(19) United States
(12) Patent Application Publication
(10) Pub. No.: US 2006/0066012 A1
(43) Pub. Date: Mar. 30, 2006

(54) Production of polymer nanocomposites using peroxides

(76) Inventors: Kumin Yang, Hopewell, NJ (US); Nathan Doyle, Hudson Falls, NY (US); Rahmi Ozisik, Niskayuna, NY (US)

Correspondence Address: ARLEN L. OLSEN;SCHMEISER, OLSEN & WATTS, 3 LEAR JET LANE, SUITE 201, LATHAM, NY, 12110, US

(21) Appl. No.: 10/949,634

(22) Filed: Sep. 24, 2004

(51) Int. Cl. B29B 7/00; B01F 13/00; B29B 15/00

(52) U.S. Cl. 264/349; 366/348

(57) ABSTRACT

A method and system for forming a polymer nanocomposite. A peroxide-degradable polymer, a clay, and a peroxide are mixed to form a polymer-clay-peroxide mixture. The polymer-clay-peroxide mixture is then heated forming a polymer-clay-peroxide melt containing peroxide radicals. The result is a degradation of the peroxide-degradable polymer within the melt to form smaller molecular weight polymer chains using the peroxide radicals and a diffusion of said polymer chains into the clay within the melt so as to exfoliate the clay to form the polymer nanocomposite having exfoliated clay being randomly dispersed throughout the polymer nanocomposite.

### BACKGROUND OF THE INVENTION

1. Field of Invention

The present invention relates to a method for the production of polymer nanocomposites comprising a polymer matrix having dispersed therein swellable clays. In particular, the present invention relates to the polymer nanocomposites having particular properties and the method for its production using peroxide-degradable polymers, modified clays, and peroxides.

2. Related Art

Methods have been developed to facilitate the exfoliation of clays in polymer-clay mixtures to generate polymer nanocomposite compositions. However, none of the existing methods efficiently disperse the clay in the polymer. Therefore, a need exists for a method of clay exfoliation that will produce polymer nanocomposites having efficient dispersion of the clay throughout the polymer nanocomposite.

### SUMMARY OF THE INVENTION

The present invention provides a method for the production of polymer nanocomposites which overcomes the aforementioned deficiencies and others inter alia provides a method for maximum and efficient dispersion of the clay throughout the polymer nanocomposite.

One aspect of the present invention is a method of forming polymer nanocomposites comprising the steps: mixing a peroxide-degradable polymer, a clay, and a peroxide to form a polymer-clay-peroxide mixture; and heating said polymer-clay-peroxide mixture to form a polymer-clay-peroxide melt containing peroxide radicals, resulting in: degradation of said peroxide-degradable polymer within said melt to form smaller molecular weight polymer chains via said peroxide radicals; a diffusion of said polymer chains into said clay within said melt so as to exfoliate said clay to form said polymer nanocomposite having an exfoliated clay being randomly dispersed throughout said polymer nanocomposite.

A second aspect of the present invention is a system for forming polymer nanocomposites comprising the steps of: a means for mixing a peroxide-degradable polymer, a clay, and a peroxide to form a polymer-clay-peroxide mixture; and a means for heating said polymer-clay-peroxide mixture to form a polymer-clay-peroxide melt containing peroxide radicals, resulting in: degradation of said peroxide-degradable polymer within said melt to form smaller molecular weight polymer chains via said peroxide radicals; a diffusion of said polymer chains into said clay within said melt so as to exfoliate said clay to form said polymer nanocomposite having an exfoliated clay being randomly dispersed throughout said polymer nanocomposite.

### BRIEF DESCRIPTION OF THE DRAWINGS

The features of the present invention will best be understood from a detailed description of the invention and an embodiment thereof selected for the purpose of illustration and shown in the accompanying drawing in which:

FIG. 1 depicts a process schematic for producing a polymer nanocomposite, in accordance with embodiments of the present invention;

FIG. 2 depicts an exfoliated polymer nanocomposite, in accordance with embodiments of the present invention;

FIG. 3 depicts a melt viscosity versus shear rate plot of polypropylene, grade ProFax 6823, at various temperatures, in accordance with embodiments of the present invention;

FIG. 4 depicts a melt viscosity versus shear rate plot of different ProFax grades of polypropylene at various temperatures, in accordance with embodiments of the present invention;

FIG. 5 depicts a melt viscosity versus shear rate plot of polypropylene, grade Valtec 800 and PolyBond 3200, at various temperatures, in accordance with embodiments of the present invention;

FIG. 6 depicts a melt viscosity versus shear rate plot of polypropylene, grade Valtec 800 with and without clay, and PolyBond 3200, at various temperatures, in accordance with embodiments of the present invention;

FIG. 7 depicts a melt viscosity versus shear rate plot of polypropylene, grade PB3200, and its polymer nanocomposites at 170° C., in accordance with embodiments of the present invention;

FIG. 8 depicts a melt viscosity versus shear rate plot of polypropylene, grade Valtec 800 and its polymer nanocomposites, in accordance with embodiments of the present invention;

FIG. 9 depicts a melt viscosity versus shear rate plot of polypropylene, grade PB3200, and its polymer nanocomposites at 200° C., in accordance with embodiments of the present invention;

FIG. 10 depicts a Gel Permeation Chromatography (GPC) calibration curve, in accordance with embodiments of the present invention;

FIG. 11 depicts a (GPC) curve of polypropylene, grade PB3200 and Valtec 800, in accordance with embodiments of the present invention;

FIG. 12 depicts a GPC curve of non-thermally degraded and thermally degraded polypropylene, grade PB3200, at 200° C., in accordance with embodiments of the present invention;

FIG. 13 depicts a GPC curve of polymer nanocomposites with varying peroxide content and mixing times, in accordance with embodiments of the present invention;

FIG. 14 depicts GPC curve of polymer nanocomposites with varying peroxide concentration and mixing times, in accordance with embodiments of the present invention;

FIG. 15 depicts wide angle x-ray diffraction (WAXD) plots of polymer nanocomposites prepared by varying the peroxide content, in accordance with embodiments of the present invention;

FIG. 16 depicts a WAXD graph of polymer nanocomposites prepared by varying mixing times, in accordance with embodiments of the present invention;

FIG. 17 depicts a WAXD graph of different polymer nanocomposites, in accordance with embodiments of the present invention;

FIG. 18 depicts a mechanism for polymer bonding with a clay, in accordance with embodiments of the present invention; and

FIG. 19 depicts a process schematic for producing a polymer nanocomposite, in accordance with embodiments of the present invention.

### DETAILED DESCRIPTION OF THE INVENTION

Although certain embodiments of the present invention will be shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc. . . . , and are disclosed simply as an example of an embodiment. The features and advantages of the present invention are illustrated in detail in the accompanying drawing, wherein like reference numeral refer to like elements throughout the drawings. Although the drawings are intended to illustrate the present invention, the drawings are not necessarily drawn to scale.

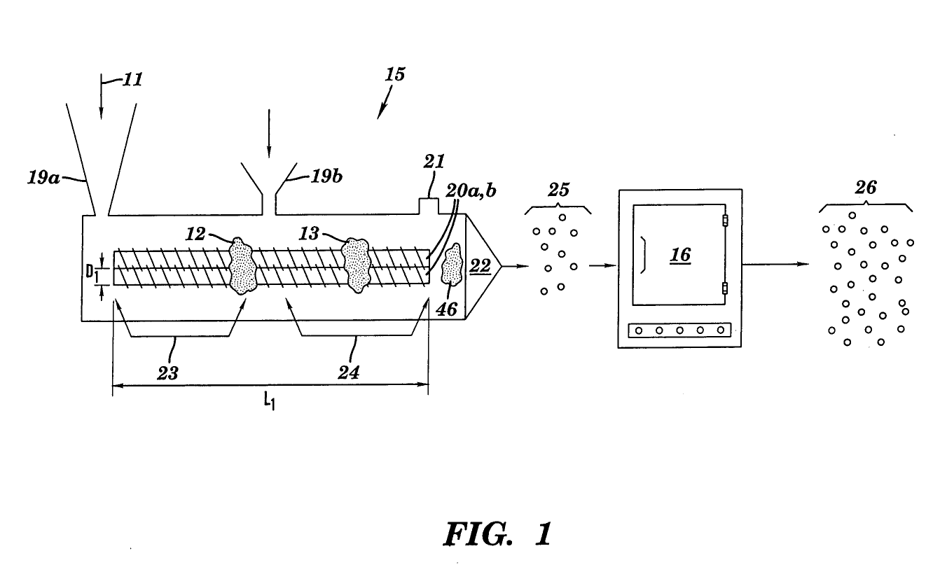

FIG. 1 depicts a process schematic for producing a polymer nanocomposite 46. A continuous process method is used for mixing a polymer, a clay, and a peroxide via a fully intermeshing, co-rotating twin screw extruder 15, in accordance with an embodiment of the present invention. The clay has a layered structure (e.g., a clay gallery). The extruder 15 may be a model such as the ZSK 30, from Werner & Pfleiderer, and the like. The twin screw extruder 15 comprises an extruder hopper 19a, an extruder hopper 19b, screws 20a and 20b, a vacuum port 21, and an extruder die 22. The length (L₁) to diameter (D₁) ratio (L₁/D₁) of each screw, 20a and 20b, may be in a range of 20 to 50 (e.g., 45).

As shown in FIG. 1, namely mixing the polymer, the clay, and the peroxide to form the polymer nanocomposite 46, is performed via the extruder 15. A mixture 11 comprising of dry blended polymer and clay is fed into the extruder 15 via the extruder hopper 19a along with thermal stabilizers and lubricants. The ratio of polymer to clay in the mixture 11 may be in a range from about 50:50 percent by weight to about 99:1 percent by weight. Alternatively, the polymer and the clay may be separately fed into the extruder 15 using hoppers 19a and 19b resulting in a final ratio of polymer to clay ranging from about 50:50 percent by weight to about 99:1 percent by weight.

The polymer-clay mixture 11 is kneaded in the first kneading block zone 23 with complete melting of the polymer forming a polymer-clay melt 12 upon exiting the zone 23. The polymer-clay melt 12 then enters the second kneading zone 24 wherein the peroxide is added to melt 12, via the extruder hopper 19b, where shear stress forces exerted by the extruder screws 20 of the extruder 15 disperse the peroxide within the melt 12 to form a polymer-clay-peroxide melt 13. The resulting ratio of the polymer to clay to peroxide within the melt 13 may be in a range of about 49.25:49.25:1.5 percent by weight to about 98.25:0.25:0 percent by weight.

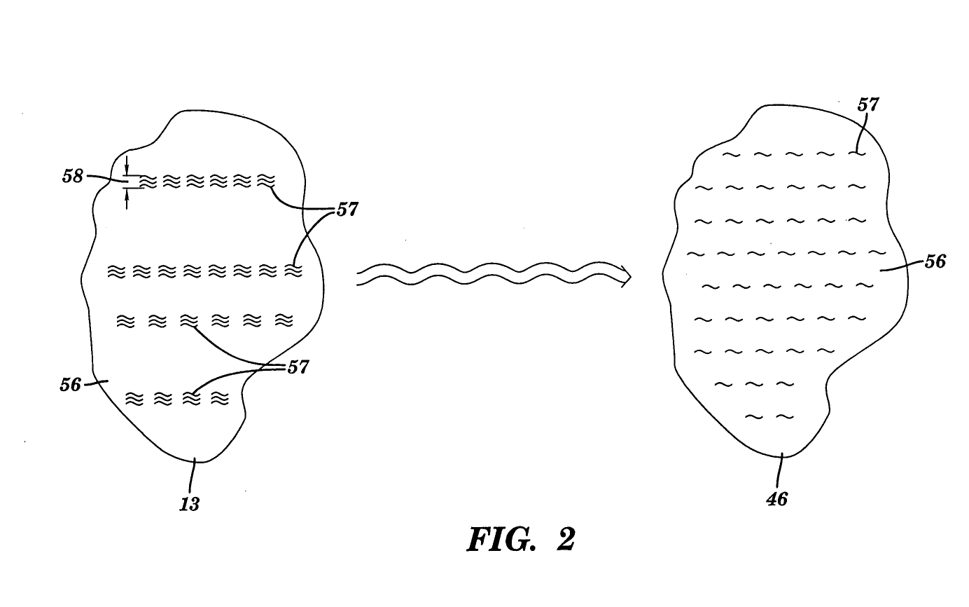

Referring to FIG. 1 and FIG. 2, the extruder 15 operates at a temperature range from about 160° C. to about 250° C., with a screw speed from about 200 rpm to about 500 rpm, and a throughput from about 10 kg/hr to about 400 kg/hr. The extruder die 22 operates at a temperature from about 160° C. to about 270° C. As the polymer-clay-peroxide melt 13 is being kneaded and heated in the second kneading zone 24, peroxide radicals are generated from the peroxide within the melt 13. As the peroxide radicals are formed, the radicals degrade the polymer 56 to form smaller molecular weight polymer chains. The polymer chains then diffuse into the clay gallery 58 upon their generation causing exfoliation of the clay 57 to form the polymer nanocomposite 46 having the clay 57 substantially dispersed throughout the polymer nanocomposite 46.

As the polymer nanocomposite 46 exits the kneading zone 24, a vacuum is applied to the extruder 15 via the vent 21 to remove any volatiles that may be present in the nanocomposite 46. The nanocomposite 46 then passes through the extruder die 22 preforming the nanocomposite 46 into pellets 25. The pellets 25 are dried at a temperature from about 65° C. to about 85° C. for about 10 hrs to about 24 hrs in a convection oven 16 affording dried pellets 26.

The order of entry of the polymer 56, the clay 57, and the peroxide addition to the co-rotating twin screw extruder 15 is not meant to limit the scope of the production process in an embodiment of the present invention. Polymer nanocomposites 46 can be produced using different means of polymer 56, clay 57, and peroxide entry into the production process. For example; the polymer 56, the clay 57, and the peroxide first may be dry blended and then added to the extruder 15 via the hopper 19a. Another alternative is to dry blend the polymer 56 and the peroxide before addition to the extruder 15. After heating and kneading under the conditions described above, the clay 57 then may be added, through the extruder hopper 19b, to form the polymer-clay-peroxide melt 13. Any order of entry as well as any combination of the polymer 56, the clay 57, and the peroxide to the production process will result in the production of polymer nanocomposites 46 of the present invention.

An alternative process for producing the polymer nanocomposite 46 is via a batch process using an internal mixer, in accordance with an embodiment of the present invention. The mixer may be a ThermoHaake Polydrive 600 mixer and the like. A mixture 11 comprising dry blended polymer 56 and clay 57 is fed into the mixer along with thermal stabilizers and lubricants. The ratio of polymer to clay in the mixture 11 may be in a range from about 50:50 percent by weight to about 99:1 percent by weight. Alternatively, the polymer 56 and clay 57 may be separately fed into the mixer resulting in a final ratio of polymer 56 to clay 57 ranging from about 50:50 percent to about 99:1 percent by weight.

Peroxide, 1.5 percent by weight, then is added to the mixer forming a polymer-clay-peroxide mixture 13. The ratio of the polymer 56 to clay 57 to peroxide within the mixture is in a range from about 49.25:49.25:1.5 percent by weight to about 98.25:0.25:0 percent by weight. The mixture is heated at temperature range from about 160° C. to about 250° C. for about 5 min. to about 20 min. at a mixer rotor speed of about 10 rpm to about 50 rpm forming a polymer-clay-peroxide melt 13.

As the polymer-clay-peroxide melt 13 is being mixed and further heated in the mixer, peroxide radicals are generated. As the peroxide radicals are formed, the radicals degrade the polymer 56 to form smaller molecular weight polymer chains. The polymer chain subsequently diffuse into the clay gallery 58 upon their generation causing exfoliation of the clay 57 to form the polymer nanocomposite 46. The polymer nanocomposite 46 has the exfoliated clay randomly dispersed throughout the polymer nanocomposite 46. Further, the nanocomposite 46 can be preformed into pellets 26 for later use; directly fed into a process line to form sheets, rods, and the like; or directly fed into a blow molding apparatus to form components comprising the polymer nanocomposite 46.

The peroxide-degradable polymers 56 used in the present invention may be selected from, inter alia, non-fluctionalized polymers such as polypropylene, butyl rubber, polyisobutylene, high density polypropylene, polyamides, polyesters and combinations thereof.

The peroxide-degradable polymers 56 used in the present invention may be further selected from, inter alia, functionalized polymers such as polypropylene grafted maleic anhydride, nylon 6, nylon 6,6, poly(acrlyonitrile), poly(ethylene terephthalate), poly(acetal), polystyrene, poly(vinyl acetate-co-vinyl alcohol), poly(vinylidene chloride), poly(vinylidene fluoride), or poly(vinyl alcohol), and combinations thereof.

The clays 57 used in the present invention may be selected from, inter alia, aliphatic fluorocarbon, perfluoroalkylpolyether, qartemary ammonium terminated poly(dimethylsiloxane), an alkyl quartemary ammonuim complex, glass fibers, carbon fibers, carbon nanotubes, talc, mica, natural smectite clay, synthetic smectite clay, montmorillonite, saponite, hectorite, vermiculite, beidellite, or stevensite, and combinations thereof.

The peroxides used in the present invention may be selected from, inter alia, bis(t-butylperoxy) diisopropyl benzene; t-butyl peroxy-2-ethylhexanoate, dicumyl peroxide (DCP), acetyl cyclohexane sulphonyl peroxide, 2,5-dimethyl-2,5-di(t-butylperoxy) hexane, t-butyl peroxy-2-ethylhexanoate, di-t-butyl peroxide, 2,5-dimethyl-2,5-di(t-butylperoxy) hexyne-3, t-butyl peroxybenzoate, bis(t-butyl peroxyisopropyl) benzene, t-butyl hydroperoxide, dilauroyl peroxide, and combinations thereof. Peroxides are organic compounds containing the peroxide link (—O—O—) which cleaves upon heating to produce a peroxide free radical. Polymer 56 degradation via peroxide radicals is based on the free radical chain theory for auto-oxidation. The steps of the polymer 56 degradation process are initiation, hydrogen abstraction, degenerate chain branching/beta-scission, hydrogen bonding and product formation, and termination.

Once the polymer 56 and peroxide have been mixed either by dry mixing (peroxide is a powder) or by solution mixing (peroxide in a solution) and the temperature is increased above a half-life temperature of the peroxide link (—O—O—), the peroxide becomes unstable and splits creating two free radicals (RO) (Equation 1).
ROOR→2RO^{●}
The free radicals then attack the polymer 56 at the tertiary hydrogen sites (T-H) and are abstracted from the main chain to form ROOH groups and a polymer alkoxy free radical (PPO). These T-H's are attacked by the RO due to the fact that these bonds have the highest dissociation energy within the system. The polymer alkoxy radicals are highly reactive with the T-H sites along with the peroxide free radicals (Equation 2).

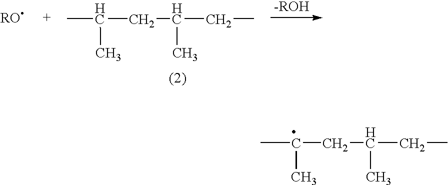

The polymer alkoxy radical causes intramolecular hydrogen bonding with a nearby polymer chain or actual abstraction of a T-H atom resulting in the polymer chain becoming unstable with subsequent beta-scission to form smaller molecular weight polymer chains. The beta-scission forms a polypropylene free radical and a carbon double bond, C═C (Equation 3). The polymer degradation reaction will naturally terminate by disproportionation at reasonable atmospheric pressure (Equation 4). Adding buffer substances to react with the peroxide and polymer free radicals more readily than the tertiary hydrogen can also prematurely stop the process.

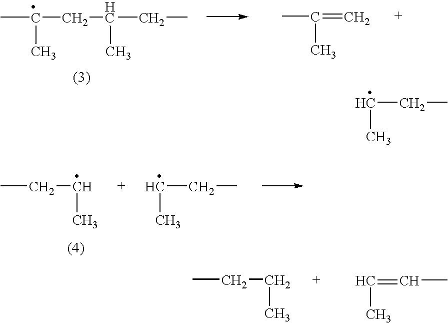

To form a polymer nanocomposite 46 comprising the polymer 56 and the clay 57, the clay gallery 58 is well exfoliated, and the exfoliates, i.e., the clay 57 or the clay layers of the gallery 58, are randomly dispersed throughout the polymer 56. Exfoliation of the clay gallery 58 and subsequent dispersion of the clay 57 is obtained when the clay 57 spacing within the gallery 58 increases to a point where there are no longer sufficient attractions between the clay 57 layers to cause uniform spacing within the gallery 58. The result is the clay 57 being randomly dispersed throughout the polymer nanocomposite 46.

A necessary condition exists for efficient clay 57 exfoliation of the polymer-clay-peroxide melt 13 of the present invention and any peroxide-degradable polymer-clay mixture in general. The peroxide present must be able to form peroxide radicals which subsequently degrade the polymer 56 of the polymer-clay-peroxide melt 13 to form smaller polymer units which then can diffuse into the clay gallery 58 of the polymer-clay-peroxide melt 13, which causes exfoliation of the clay gallery 58 to form a polymer nanocomposite 46 having the exfoliated clay 57 randomly dispersed throughout the polymer nanocomposite 46.

Capillary rheology, wide angle x-ray diffraction (WAXD), thermal analysis (pyrolysis), and gel permeation chromatography (GPC) are used to study and characterize the polymer nanocomposites 46. Capillary rheometry is used to evaluate the effect of clay 57 and peroxide on the melt viscosity of the polymer nanocomposites 46. The viscosity of the polymer 56 and polymer nanocomposites 57 of the present invention were calculated was based upon the Rabinowitch-Mooney equation (Eq. 7). Equation 5 represents the shear stress at the wall, t_{w}.

$$\begin{matrix}{τ}_{w} = ( \frac{δ p}{δ z} ) \frac{R}{2} \\ \text{where:} \\ ( \frac{δ p}{δz} ) = \text{Pressure gradient over the length of the capillary.} \\ R = Radius of the capillary .\end{matrix} \qquad ( 5 )$$

Equation 6 represents the apparent shear rate, γₐₚₚ.

$${γ}_{app} = ( \frac{4 Q}{π {R}^{3}} ) = \frac{8 \overline{V}}{D} \qquad ( 6 )$$

where:
Q=Volumetric flow rate.
\overline{V}=Average velocity of the fluid in the capillary.
D=Diameter of the capillary.
Once the corrected shear rate is found, a plot of (ln τ_{w}) vs. (ln γₐₚₚ) was prepared. The slope of this curve can then be used to find the corrected shear rate using Equation 7.

$$\begin{matrix}{γ}_{w} = ( \frac{( 3 n + 1 )}{4 n} ) {γ}_{app} \\ \text{Where:} \\ n = \frac{ⅆ ln {τ}_{w}}{ⅆ ln {γ}_{app}} = \text{slope of the plot}\end{matrix} \qquad ( 7 )$$

The corrected viscosity was calculated by taking the ratio of the wall shear stress over the corrected shear rate.

An Instron capillary rheometer model 3211 was used to characterize the viscosities of the samples. The samples, in the form of pellets, were fed into the reservoir the as received. The capillary had a diameter of 1.2725 mm and a length of 77.859 mm. Three different grades of industrial polypropylene: Profax 6823 (PF6823), Profax 6523 (PF6523), and Profax 6433 (PF6433) were evaluated at 180° C., 200° C., 220° C., and 240° C. Polypropylene grafted maleic anhydride, PolyBond 3200 (PB3200); polypropylene, Valtec 800 (V800); polymer nanocomposites 46; PB3200/Cloisite 20A, PB3200/Cloisite 20A/dicumylperoxide; and V800/Cloisite 20A were evaluated at 170° C., 185° C., and 200° C.

All samples were tested at speeds of 0.06, 0.2, 0.6, 2.0, 6.0, and 20.0 cm/minute. The force was obtained using a 2000 kg load cell attached to the plunger, and recorded with an XY analog plotter. The force then was entered into an Excel spreadsheet macros, and viscosity versus. shear rate curves were calculated. Table 1 and Table 2 contain the true viscosities.

TABLE 1
True viscosity for polypropylene (PP).

| PF6823 | | | | PF6523 | | | | PF6433 | | | |
|---|---|---|---|---|---|---|---|---|---|---|---|
| 180 | 200 | 220 | 240 | 180 | 200 | 220 | 240 | 180 | 200 | 220 | 240 |
| Viscosity (Pa * s) | | | | Viscosity (Pa * s) | | | | Viscosity (Pa * s) | | | |
| N/A | 10323 | 6805 | 5193 | 4212 | 3203 | 2297 | 1462 | 3179 | 2518 | 1422 | 1035 |
| N/A | 4262 | 3093 | 2539 | 2089 | 1774 | 1316 | 703 | 1731 | 1320 | 899 | 641 |
| N/A | 1907 | 1306 | 1209 | 1119 | 895 | 710 | 481 | 893 | 747 | 527 | 398 |
| N/A | 738 | 598 | 490 | 513 | 425 | 342 | 287 | 416 | 350 | 288 | 237 |
| N/A | 297 | 257 | 214 | 227 | 199 | 162 | 147 | 197 | 167 | 147 | 125 |
| N/A | 109 | 92 | 80 | 92 | 83 | 70 | 66 | 79 | 74 | 66 | 57 |

Note:
N/A = not applicable.

TABLE 2
True viscosity for Low MW PP, PB3200, and composites.

| | | | | | | | | | | | | PB3200/20 | | |
|---|---|---|---|---|---|---|---|---|---|---|---|---|---|---|
| V800 | | | V800/20 A | | | PB3200 | | | PB3200/20 A | | | A/0.5 DCP | | |
| 170 | 185 | 200 | 170 | 185 | 200 | 170 | 185 | 200 | 170 | 185 | 200 | 170 | 185 | 200 |
| Viscosity | | | Viscosity | | | Viscosity | | | Viscosity | | | Viscosity | | |
| (Pa * s) | | | (Pa * s) | | | (Pa * s) | | | (Pa * s) | | | (Pa * s) | | |
| 90 | N/A | N/A | N/A | N/A | N/A | 177 | N/A | N/A | 234 | N/A | N/A | 145 | N/A | N/A |
| 66 | 43 | 30 | 72 | 59 | 41 | 128 | 99 | 68 | 157 | 111 | 66 | 106 | 91 | 82 |
| 47 | 32 | 25 | 53 | 36 | 27 | 95 | 75 | 53 | 109 | 79 | 50 | 75 | 62 | 46 |
| 33 | 24 | 20 | 38 | 26 | 20 | 70 | 55 | 40 | 65 | 52 | 36 | 50 | 43 | 31 |
| 18 | 16 | 14 | 23 | 17 | 13 | 43 | 35 | 27 | 35 | 29 | 20 | 30 | 24 | 18 |

Note:
N/A = not applicable.

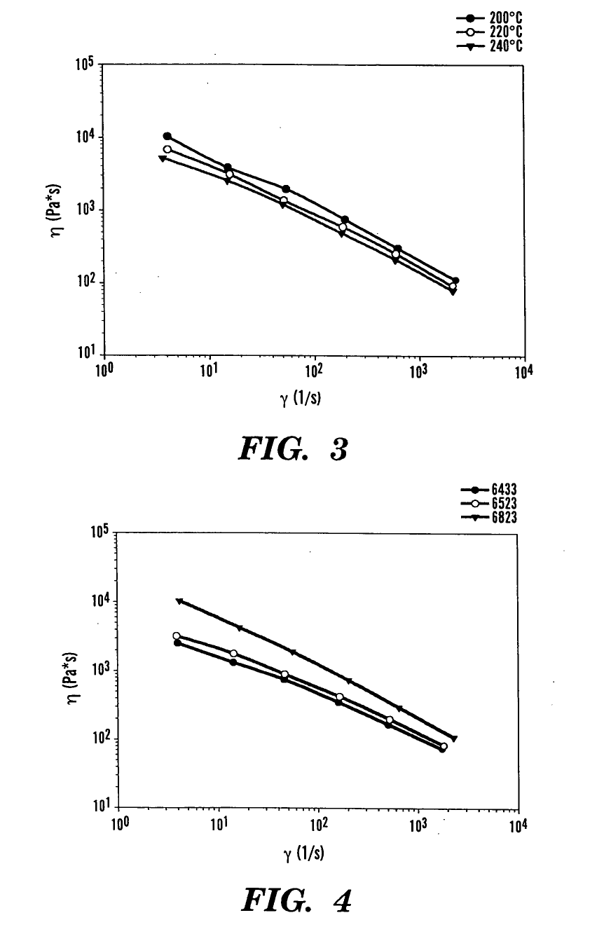

The graphs of true viscosity vs. corrected shear rate can be seen in FIGS. 3-9. Data for PF6823 at 180° C. could not be taken due to the force being over the limit of the load cell. The force data at 0.06 cm/min for all temperatures, and the data at 0.2 cm/min for the temperatures at 185° C. and 200° C. could not be determined for the grades PB3200, V800 and the polymer nanocomposites due to the load cell not being sensitive to these low forces.

FIG. 3 depicts the melt viscosity versus the shear rate of polypropylene grade PF6823 at various temperatures.

FIG. 4 depicts the melt viscosity versus the shear rate at 200° C. for the Profax grades of polypropylene.

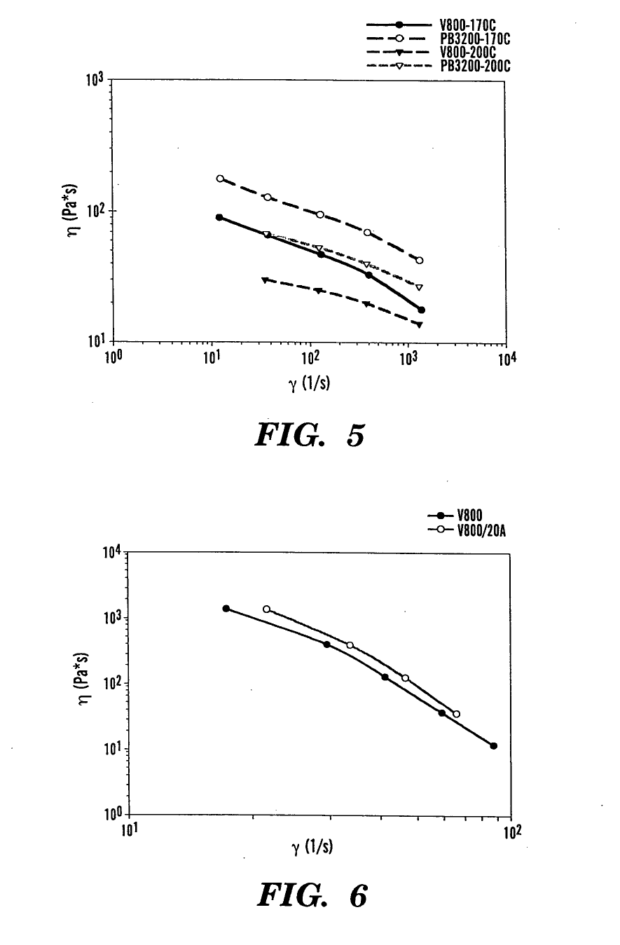

FIG. 5 depicts the melt viscosity versus the shear rate of V800 and PB3200 at 170° C. and 200° C.

FIG. 6 depicts the melt viscosity versus the shear rate of V800 at 170° C. with and without clay (Cloisite 20A).

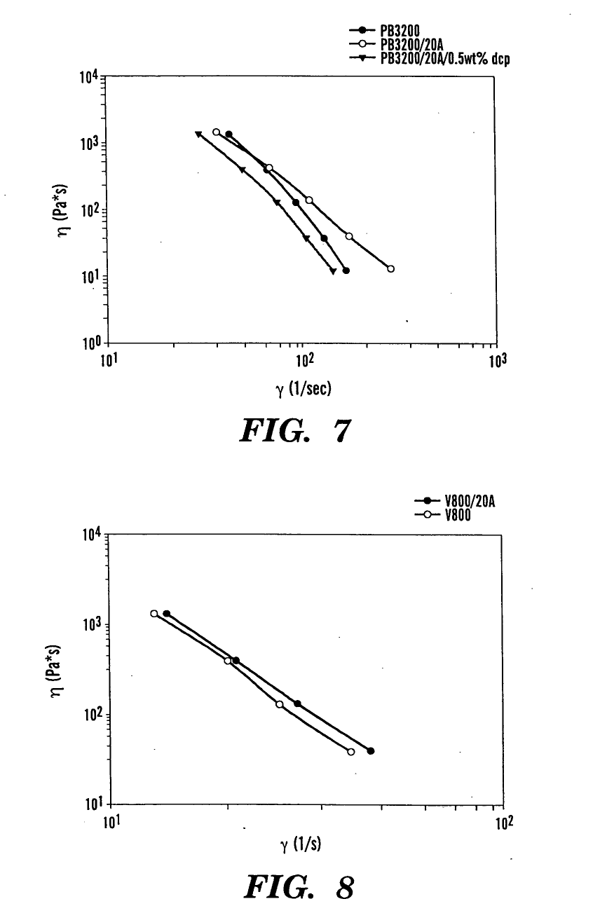

FIG. 7 depicts the melt viscosity versus the shear rate at 170° C. of PB 3200, PB3200/20A and PB3200/20A/0.5 percent by weight dicumyl peroxide.

FIG. 8 depicts the melt viscosity versus the true shear rate of V800 at 200° C. with and without clay (Cloisite 20A).

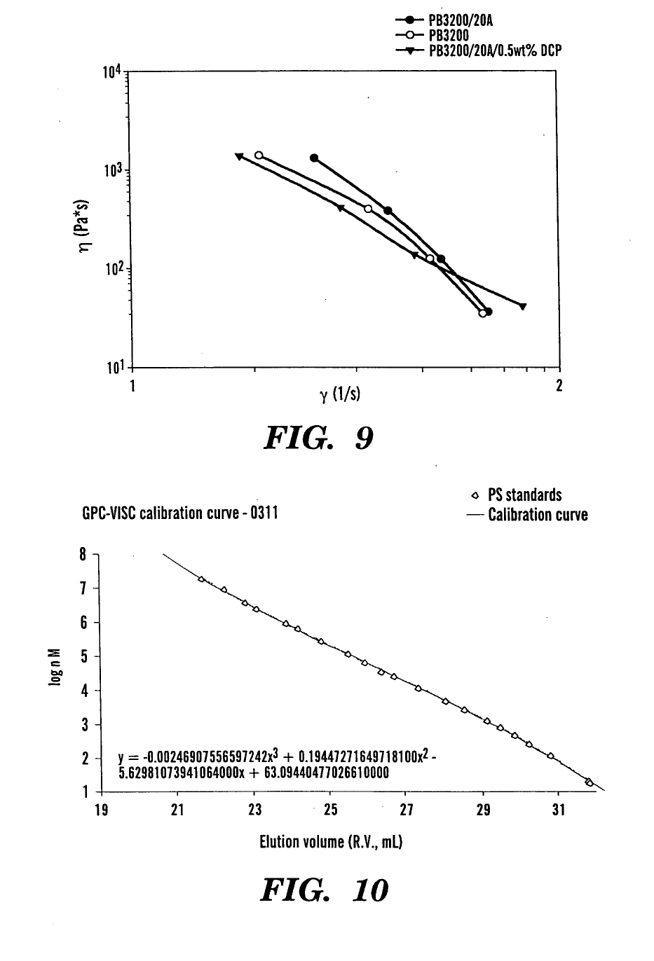

FIG. 9 depicts the melt viscosity versus the true shear rate of PB3200, PB3200/20A and PB3200/20A/0.5 percent by weight dicumyl peroxide at 200° C.

Pyrolysis experiments were performed to determine the organic and the inorganic content of the polymer nanocomposites 46. A Rapid Temperature Furnace made by CM Inc. was used to perform the pyrolysis experiments. Ceramic (Al₂O₃) cups were weighed filled with 2-3 grams of the polymer nanocomposite 46. All samples were placed in a furnace at room temperature and then ramped up to 900° C. and held there for 24 hours. The cups were removed from the furnace and weighed. The inorganic content of the polymer naonocomposites 46 were found by burning off the organic (polymer) material in a furnace, and then calculating the weight percent using initial and final weights using Equations 10 & 11:

$$wt \% = [ 1 - ( \frac{{M}_{i} - {M}_{f}}{{M}_{i}} ) ] * 100 \% \qquad ( 10 )$$

where: wt %=Inorganic weight percent.
Mᵢ=Initial mass (grams).
M_{f}=Final mass (grams).

$$\% Error = \frac{( wt \% - Lwt \% )}{Lwt \%} \qquad ( 11 )$$
where: Lwt %=literature weight percent.

Pyrolysis data of the polymer nanocomposite 46; PB3200, Cloisite 20a, and 0.75% of DCP mixed for 20 min., shows the nanocomposite 46 to comprise 96.90% organic material and 3.10% inorganic material. The expected value for the inorganic material present is 3.05%. The percent error is 1.64%. Further data of the polymer nanocomposite 46, PB3200, Cloisite 20a, and 1.5% of DCP, shows the nanocomposite 46 to comprise of 96.95% organic material and 3.05% inorganic material. The expected value for the inorganic material present is 3.05%. The percent error for the amount of inorganic material present in the polymer nanocomposite 46 is 0.00%.

Gel permeation chromatography (GPC) runs were performed to evaluate the peroxide efficiency in causing polymer 56 degradation. Dicumyl peroxide (DCP) at various concentrations was added to 100 wt % PB3200 and mixed for various time lengths. The DCP was dry-mixed with the PB3200 in a bag at weight percents 0.0, 0.25, 0.5, 0.75, 1.5 at mixing times of 5, 7.5, and 10 min. Without any DCP (0.0 wt % DCP), thermal degradation of the polymer 56 took place during mixing. The efficiency of the peroxide was obtained from the changes in molecular weight and molecular weight distribution. Mixing time did not affect the results, only the concentration of the peroxide was found to affect its efficiency in degrading the polymer 56 into smaller molecular weight polymer chains.

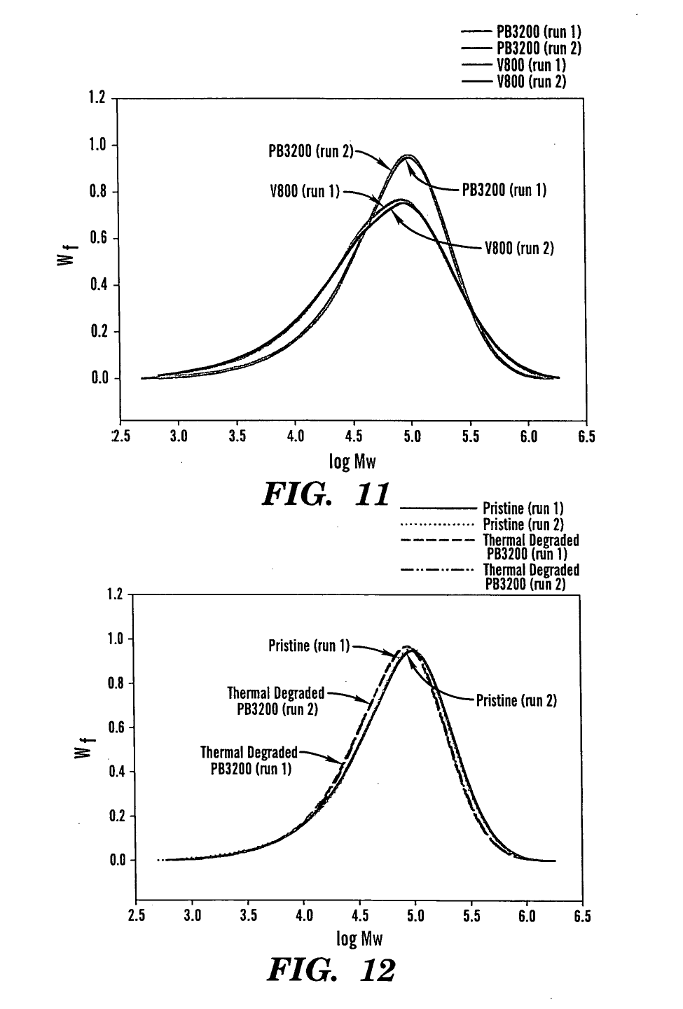

FIG. 10 depicts a GPC-viscosity polystyrene calibration curve used. Two GPC runs of each sample (PF6823, V800, PB3200 and PB3200/DCP) were performed. Trichlorobenzene was utilized as the solvent at temperature of 150° C. Table 3 lists the weight average molecular weight (M_{w}) averages and polydispersity index (PDI) for the grades PF6823, V800, PB3200, and degraded PB3200 are given. FIGS. 11-14 show weight fraction (W_{f}) vs. molecular weight (log M_{w}) GPC curves for each grade. The percent efficiency of DCP was calculated using Equation 12.

$$\% Efficiency = \frac{[ {Mw}^{*} - Mw ( x ) ]}{{Mw}^{*}} \qquad ( 12 )$$

Where: Mw*−Molecular weight average of pure PB3200.

Mw(x)−Molecular weight average of a composite.

TABLE 3
Weight Average Molecular Weight (M_{w}), Polydespersity
Index (PDI), and % Efficiency averages.

| Sample | M_{w} | PDI | % Efficiency |
|---|---|---|---|
| PB3200 | 113,257 | 3.60 | N/A |
| V800 | 114164 | 5.52 | N/A |
| PF6823 | 900,054 | 6.20 | N/A |
| PB3200/0 wt % DCP 5 min | 100,797 | 3.21 | 11.00% |
| PB3200/0 wt % DCP 10 min | 102,132 | 3.27 | 9.82% |
| PB3200/0.75 wt % DCP 5 min | 75,963 | 2.99 | 32.93% |
| PB3200/0.75 wt % DCP 10 min | 75,090 | 3.01 | 33.70% |
| PB3200/0.5 wt % DCP 10 min | 78,905 | 3.29 | 30.33% |
| PB3200/1.5 wt % DCP 10 min | 83,923 | 3.01 | 25.90% |

Note:
N/A = not applicable.

Wide angle X-ray diffraction (WAXD) is used to characterize the raw materials and quantify the amount of exfoliation and dispersion of the clay 57 within the polymer 56 through change in d-spacing (distance between) of the clay 57 and the intensity of the diffracted peak. A Scintag X-ray diffractometer and Scintag software were used to perform these tests. Clay 57 and dicumyl peroxide were prepared in powder form and placed on a glass slide using petroleum jelly. Polymer 56 samples were pressed flat to a film size of 2 mm×25.4 mm×25.4 mm using a hot press. All samples were analyzed from 0.5° to 15° at 0.5° per minute. The diffractometer uses a copper source with a wavelength of 1.54 Å.

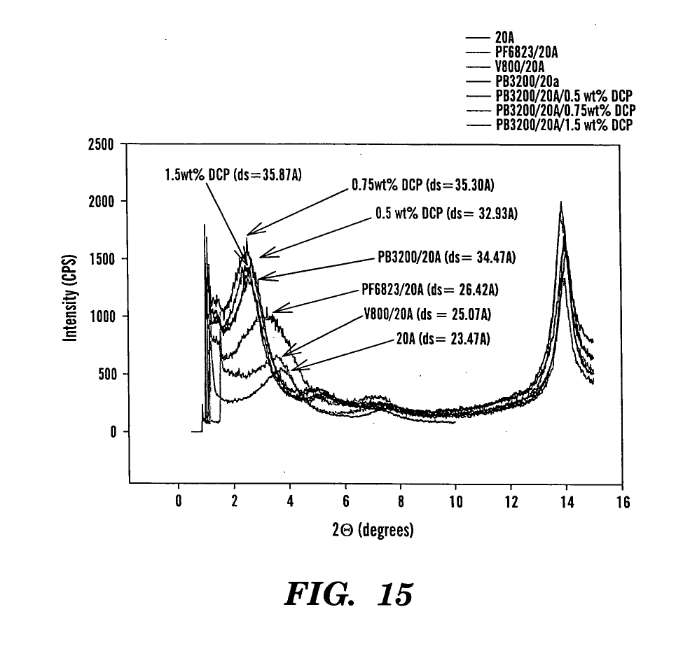

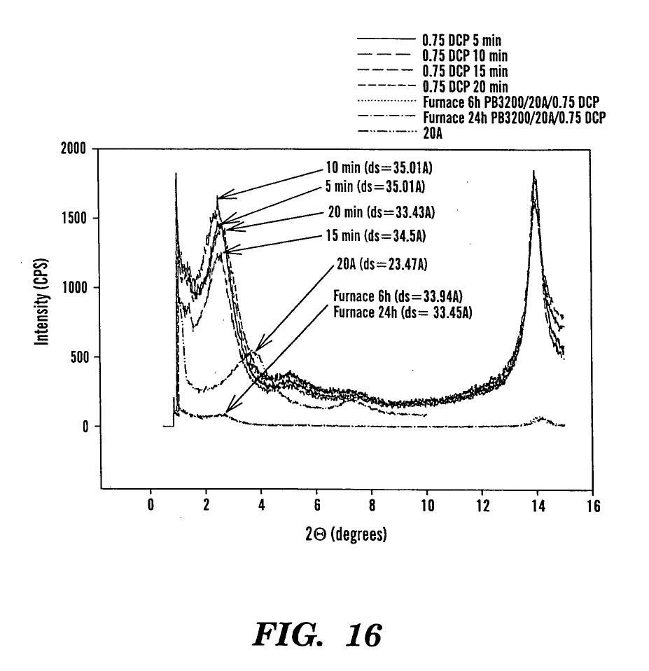

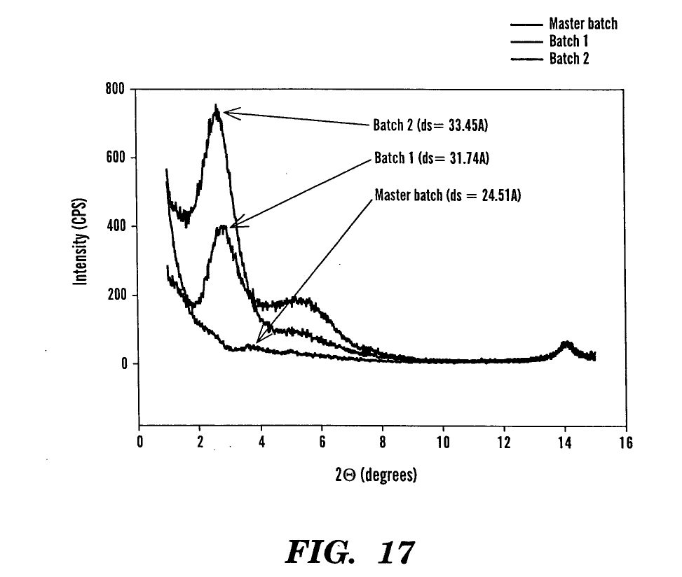

WAXD was used to see the effect of the various conditions on the clay 57 spacing or d-spacing. The Scintag Diffractometer displays the data in graphs of Intensity [counts per second, (CPS)] versus diffraction angle, 2θ. FIGS. 15-17 depict WAXD plots in accordance with the present invention. The peak intensity was calculated using a best-fit trend line function and finding its maximum point. Table 4 lists the d-spacings and the 2θ for the corresponding polymer nanocomposite 46 systems. The time denotes how long the sample was run in the mixer.

TABLE 4
Clay d-spacing values for various compositions.

| | | d-spacing |
|---|---|---|
| Composition | 2θ (degrees) | (Angstroms) |
| Na+ | 7.62 | 11.59 |
| 20 A | 3.76 | 23.47 |
| V800/20 A | 3.52 | 25.07 |
| PF6823/20 A | 3.34 | 26.42 |
| PB3200/20 A | 2.56 | 34.47 |
| PB3200/20 A/0.5 DCP | 2.68 | 32.93 |
| PB3200/20 A/0.75 DCP | 2.56 | 34.47 |
| 5 min | | |
| PB3200/20 A/0.75 DCP | 2.5 | 35.3 |
| 10 min | | |
| PB3200/20 A/0.75 DCP | 2.55 | 34.61 |
| 15 min | | |
| PB3200/20 A/0.75 DCP | 2.6 | 33.94 |
| 20 min | | |
| PB3200/20 A/1.5 DCP | 2.46 | 35.87 |
| PB3200/20 A Furnace | 2.68 | 32.93 |
| 24 h | | |
| PB3200/20 A/0.75 DCP | 2.6 | 33.94 |
| Furnace 6 h | | |
| PB3200/20 a/0.75 DCP | 2.64 | 33.45 |
| Furnace 24 h | | |
| Masterbatch | 3.6 | 24.51 |
| Batch 1 | 2.78 | 31.74 |
| Batch 2 | 2.64 | 33.45 |

During processing to form the polymer nanocomposite 46, the temperature needs to be in a proper range for each specific application/material so that the rheological state of the material can be controlled to produce a final product with the utmost quality. Melt viscosity data obtained using the capillary rheometer provided the temperature parameters of the present invention. Referring to FIGS. 3 and 4, the melt viscosity versus shear rate curve shows that for a particular polypropylene grade, viscosity decreases as temperature increases as expected. However, very little change was observed over the three temperatures used.

As DCP is introduced to the system and the temperature is increased, the DCP activates and begins the degradation of the polymer. The half-life of peroxide is solely dependent on the temperature of the system, and as the temperature increases, the half-life decreases. The relationship between the half-life and the temperature is demonstrated by Equation 14:

$${t}_{1 / 2} = 35 \times {10}^{- 14} ⅇ ( \frac{1497}{T} )$$

where: t_{1/2}=Half life of peroxide in seconds.
T=Processing temperature in Kelvin.

Referring to FIGS. 6-9, the addition of clay at temperatures 170° C. and 200° C. increases the viscosity of the system compared to the pure polymer. At 200° C., the maximum shear rate data is larger for the nanocomposite 46: PB3200/Cloisite 20A/DCP sample compared to either the PB3200 or the PB3200/Cloisite 20A. This is primarily due to the excessive shear rate causing extensive polymer chain degradation which would be minimized when the DCP is added. Due to the viscous properties of pure polypropylene and the moderate half-life of the DCP, 200° C. was used as the standard mixing temperature.

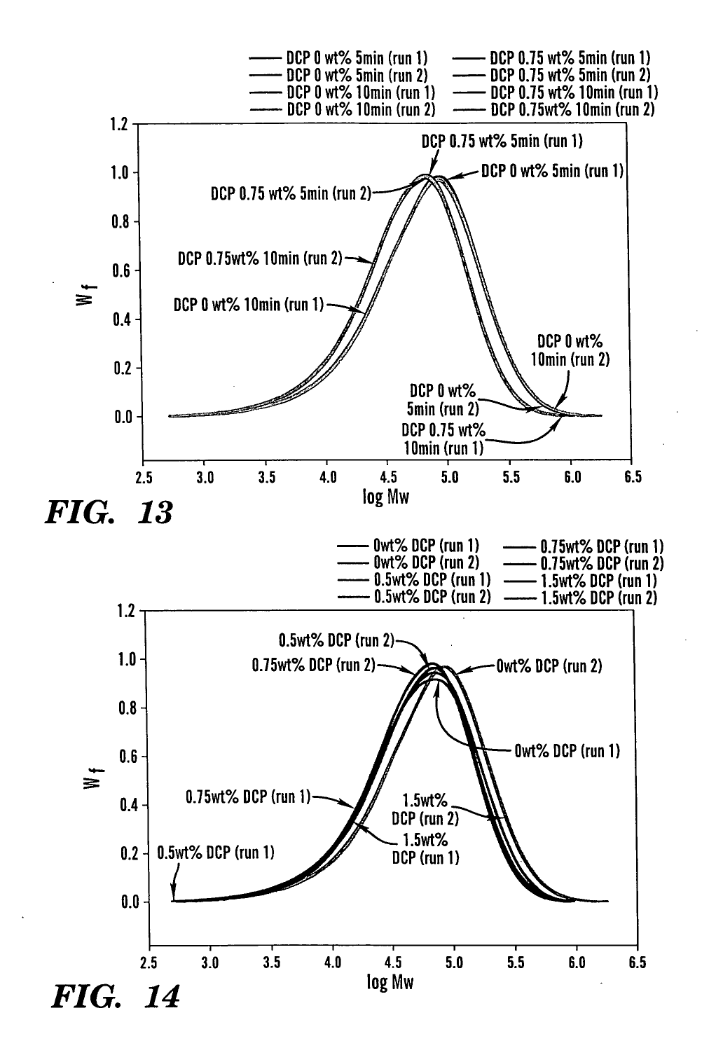

Referring to FIG. 13 and FIG. 15, the mixing time was found to have little or no effect on the degree of thermal or peroxide degradation. The difference between 5 and 10 minutes of mixing is negligible. However, the changes in the d-spacing of the clay 57 are noticeable. Samples with varied mixing time (5, 10, 15, 20 minutes) were analyzed to see if increased mixing time would aid the diffusion of degraded polypropylene chains into the clay galleries 58. Two samples, PB3200/Cloisite 20A and PB3200/Cloisite 20A/0.75 wt % DCP, were mixed for 10 min. and placed in a vacuum furnace at the processing temperature of 200° C. The samples were annealed for 24 hours with sampling at 12 hour intervals. This was done to examine if the polymer chains existing in the clay gallery diffused out or not in a static condition.

The WAXD curve shows that as mixing time is increased the d-spacing is increased between the 5 min sample to the 10 min sample. Polyproylene grafted maleic anhydride (PB3200) is attracted to the clay and will chemically bond with the clay surface.

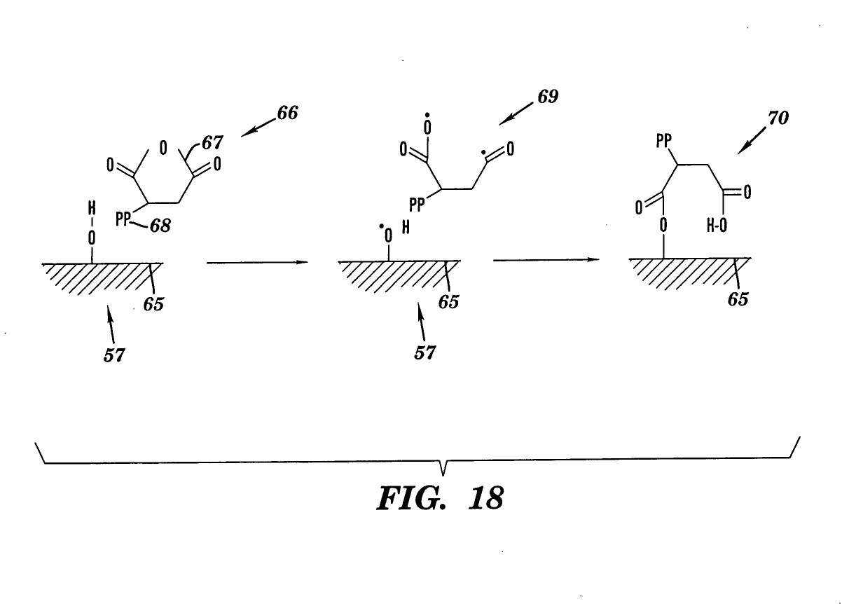

FIG. 18 depicts a mechanism for polymer bonding with the clay 57, in accordance with an embodiment of the present invention. Referring to FIG. 18, the maleic anhydride (MAH) 67 of a polypropylene grafted-MAH 66 is used as an adhesive. As the temperature increases, the MAH 67, which is grafted onto the polypropylene 68, breaks down and creates a polypropylene free radical 69 that can bond with a clay surface 65 forming a polypropylene grafted-MAH bonded clay 70 on. Therefore, the higher the temperature conditions, the better the effects of the adhesive. Even though PB3200 (MAH content of 1 wt %) and V800 (0 wt % MAH) have similar molecular weight and polydispersity, their flow behavior is different. This is primarily due to the MAH 67 interaction with the metallic surface of the capillary rheometer and other polypropylene grafted MAH 66.

The surface of the clay 65 has hydroxyl (OH). As temperature rises, the C—O bond on MAH 67 and O—H bond of the hydroxyl group on the clay surface 65 are broken. This allows for the carbon on the MAH 67 to bond with the oxygen on the clay surface 65, creating a covalent bond between the polypropylene chain 68 and the clay surface 65.

The covalent bond between polypropylene chain 68 and clay 57 helps in the separation of clay tactoids. Also due to the high chemical affinity of MAF 67 and the clay surface 65, the smaller molecular weight polymer chains (polypropylene-MAH) are more likely to diffuse into the clay gallery 58. This effect can be seen in FIG. 15. The presence of MAH 67 increased the d-spacing of the clay 57 over 65% when compared to similar M_{w} (V800).

Referring to Equations 1-4 and Table 3, the DCP breaks down to form two free radicals when the temperature is increased. The free radicals attack the polypropylene chain at the tertiary hydrogen bond creating smaller molecular weight polymer chains and hence, lowering the overall weight average molecular weight (M_{w}). The amount of degradation increased and the Mw decreased as the concentration of the DCP increased from 0.5 wt % to 0.75 wt %. However, when the concentration of the DCP increased from 0.75 wt % to 1.5 wt % the M_{w} increased. The DCP is used not only as an initiator for polymer 56 degradation but also for polymerization. When the concentration of DCP exceeds a certain point, the DCP initiates polypropylene chain radicals to react with each other, increasing the M_{w}, the melt viscosity, and the d-spacing. Along with the M_{w}, the PDI also decreases means that the length of the polymer chains is becoming more homogeneous.

The DCP free radicals will not react with the MAH 67 or clay surface 65 defects. As the temperature increases, the DCP and the MAH 67 break down to their respective free radicals. The DCP free radicals and the MAH free radicals do not bond with each other. Also the DCP does not attack the hydroxyl group on the clay surface 65 since this oxygen is more attracted to the carbon of the MAH 67. The hydrogen of the hydroxyl group is more apt to bond with the oxygen of the MAH 67, leaving the DCP to attack the tertiary hydrogen of the polypropylene chain.

The addition of the DCP not only decreases the M_{w} (shortens the chains length forming smaller molecular weight polymer chains) but also decreases the viscosity drastically, see FIG. 7. This decrease in M_{w} offsets one advantage of higher MW polymer nanocomposites, shear stress. The smaller polymer chains cannot create enough shear stress to break apart or separate the clay layers due to their low viscosity. However, as the DCP concentration increases the d-spacing increases resulting in the shorter PP chains diffusing into the clay layers. This is not due to the shear stress but due to the degradation of the polymer 56.

The polypropylene grafted maleic anhydride 66 that is bonded onto the clay surface 65 within the clay gallery 58 degrades with the addition of the DCP and the degraded chains become trapped within the gallery 58. As degradation progresses, enough free chains within the gallery 58 build up and are able to expand/exfoliate the clay 57 causing an increase in the d-spacing to a point where the exfoliated clay is randomly dispersed throughout the polymer nanocomposite 46.

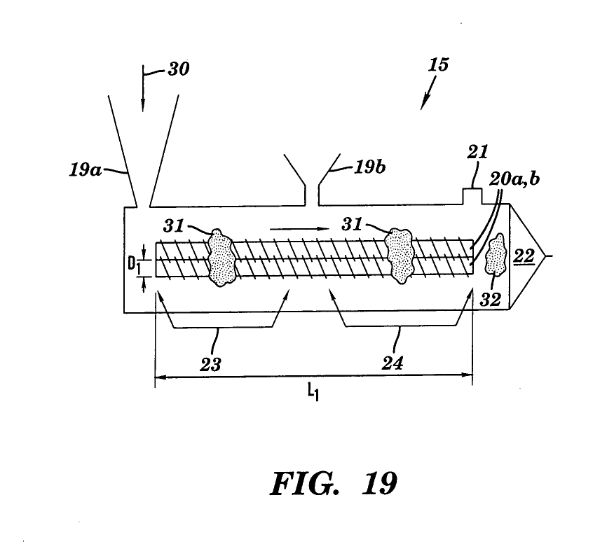

The polymer nanocomposites 46 can be reinforced by mixing the nanocomposite 46 with high molecular weight polypropylene. The polymer nanocomposite 46, masterbatch, is produced consisting of 87.5 wt % PB3200, 12.5 wt % Cloisite 20A, and 1.5 wt % DCP via either the batch or continuous process described earlier. The weight percentages have been adjusted to insure a 5 wt % of clay to 95 wt % of polypropylene to polypropylene grafted MAH in the nanocomposite 46. The reinforcement is accomplished by using either the batch or continuous process methods with nanocomposite 46. FIG. 19 depicts a process schematic for producing a reinforced polymer nanocomposite 32, in accordance with an embodiment of the present invention. Referring to FIG. 19, a mixture 30 comprising dry blended polymer nanocomposite 46 and polypropylene, ProFax grade PF6823, is fed into the extruder 15 via the extruder hopper 19a. Thermal stabilizers and lubricants may or may not be added at this stage of production process at the convenience of the user. The ratio of the nanocomposite 46 to PF6823 in the mixture 30 may be in a range from about 50:50 percent by weight to about 99:1 percent by weight.

The nanocomposite-polymer mixture 30 is kneaded in the first kneading block zone 23 with complete melting of the mixture 30 forming a nanocomposite-polymer melt 31 upon exiting the zone 23. The melt 31 then enters the second kneading zone 24 where further kneading and heating is performed as well as the exertion of mechanical stress by the extruder screws 20 of the extruder 15 on the melt 31. The resulting polymer nanocomposite 32 (batch 1) comprises the polymer to clay to peroxide in a range of about 49.25:49.25:1.5 percent by weight to about 98.25:0.25:1.5 percent by weight. The PF6823 was used in the production of batch 1 to increase viscosity to create the necessary shear stress to break apart clay tactoid.

Another nanocomposite (batch 2) was produced as above. The difference being that the mixture added to the co-rotating twin screw extruder 15 comprised dry blended nanocomposite 46 and two different grades of polyproylene, PF6823 and ProFax 3200. The ratio of nanocomposite 46 to PF6823 to PF3200 in the mixture may be in a range from about 40:40:20 percent by weight to about 30:30:40 percent by weight. Batch 2 can be produced by using either the batch or continuous process methods described earlier. The resulting polymer nanocomposite (batch 2) comprises polymer to clay to peroxide in a range of about 49.625:49.625:0.75 percent by weight to about 98.625:0.625:0.75 percent by weight. A combination of PF6823 and PB3200 was used in Batch 2 to take advantage of MAH 67 as an adhesive to aid the separation of the clay layers.

Referring to FIG. 17, the masterbatch has a very weak peak at a 2θ of 3.6°, which corresponds to a d-spacing of 24.51 Å. This is because the clay content present overwhelms the ability of the polypropylene grafted MAH to bond and separate the clay layers. The curve for batch 1 shows significant improvement in d-spacing (31.74 Å) upon dilution of the masterbatch's clay content. Batch 2 showed the highest improvement in d-spacing, 33.45 Å, where both the PB3200 and high MW PF6823 were used.

The foregoing description of the embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included withing the scope of this invention as defined by the accompanying claims.

What is claimed is:

1. A method of forming polymer nanocomposites comprising the steps of:
mixing a peroxide-degradable polymer, a clay, and a peroxide to form a polymer-clay-peroxide mixture; and
heating said polymer-clay-peroxide mixture to form a polymer-clay-peroxide melt containing peroxide radicals, resulting in:
degradation of said peroxide-degradable polymer within said melt to form smaller molecular weight polymer chains via said peroxide radicals;
a diffusion of said polymer chains into said clay within said melt so as to exfoliate said clay to form said polymer nanocomposite having an exfoliated clay being randomly dispersed throughout said polymer nanocomposite.

2. The method of claim 1, wherein said mixing is performed for about 5 min. to about 20 min.

3. The method of claim 1, wherein said peroxide-degradable polymer is selected from a group consisting of polypropylene, butyl rubber, polyisobutylene, high density polypropylene, polyamides, polyesters, and combinations thereof.

4. The method of claim 1, wherein the clay is selected from a group consisting of the aliphatic fluorocarbon, perfluoroalkylpolyether, quartemary ammonium terminated poly(dimethylsiloxane), an alkyl quartemary ammonuim complex, glass fibers, carbon fibers, carbon nanotubes, talc, mica, natural smectite clay, synthetic smectite clay, montmorillonite, saponite, hectorite, vermiculite, beidellite, or stevensite, and combinations thereof.

5. The method of claim 1, wherein the peroxide is selected from the group consisting of bis(t-butylperoxy) diisopropyl benzene; t-butyl peroxy-2-ethylhexanoate, dicumyl peroxide (DCP), acetyl cyclohexane sulphonyl peroxide, 2,5-dimethyl-2,5-di(t-butylperoxy) hexane, t-butyl peroxy-2-ethylhexanoate, di-t-butyl peroxide, 2,5-dimethyl-2,5-di(t-butylperoxy) hexyne-3, t-butyl peroxybenzoate, bis(t-butyl peroxyisopropyl) benzene, t-butyl hydroperoxide, dilauroyl peroxide, and combinations thereof.

6. The method of claim 1, wherein said heating is for about 5 min. to about 20 min.

7. The method of claim 6, wherein the polymer-clay-peroxide mixture is heated at a temperature of about 170° C. to about 200° C.

8. The method of claim 1, wherein said exfoliated clay, substantially dispersed throughout the polymer nanocomposite, has a spacing from about 23.47 angstroms to about 35.87 angstroms.

9. The method of claim 1, wherein the polymer nanocomposite has a polydispersity index from about 2.99 to about 3.21.

10. The method of claim 1, wherein said polymer-clay-peroxide mixture comprises from about 0.10 percent by weight to about 2.0 percent by weight peroxide.

11. The method of claim 1, wherein said polymer-clay-peroxide mixture comprises from about 3 percent by weight to about 15 percent by weight clay.

12. The method of claim 1, wherein said polymer-clay-peroxide mixture comprises from about 80 percent by weight to about 95 percent by weight peroxide-degradable polymer.

13. The method of claim 1, wherein said polymer nanocomposite comprises from about 1 percent by weight to about 7 percent by weight clay.

14. The method of claim 1, further comprising: mixing the polymer nanocomposite with at least one polymer to form a nanocomposite-polymer mixture, and heating said nanocomposite-polymer mixture resulting in a reinforced polymer nanocomposite.

15. The method of claim 14, wherein said polymer is selected from a group consisting of polypropylene, butyl rubber, polyisobutylene, high density polypropylene, polyamides, polyesters, and combinations thereof.

16. The method of claim 14, wherein said heating is for about 5 min. to about 20 min.

17. The method of claim 14, wherein said heating is at a temperature of about 170° C. to about 200° C.

18. The method of claim 14, wherein said mixing is performed for about 5 min. to about 20 min.

19. A system for forming polymer nanocomposites comprising the steps of:
means for mixing a peroxide-degradable polymer, a clay, and a peroxide to form a polymer-clay-peroxide mixture; and
means for heating said polymer-clay-peroxide mixture to form a polymer-clay-peroxide melt containing peroxide radicals, resulting in:
degradation of said peroxide-degradable polymer within said melt to smaller molecular weight polymer chains via said peroxide radicals;
a diffusion of said polymer chains into said clay within said melt so as to exfoliate said clay to form said polymer nanocomposite having an exfoliated clay being randomly dispersed throughout said polymer nanocomposite.

20. The system of claim 19, wherein said polymer is selected from a group consisting of polypropylene, butyl rubber, polyisobutylene, high density polypropylene, polyamides, polyesters, and combinations thereof..

21. The system of claim 19, wherein said clay is selected from the group consisting of an aliphatic fluorocarbon, perfluoroalkylpolyether, quartemary ammonium terminated poly(dimethylsiloxane), an alkyl quartemary ammonuim complex, glass fibers, carbon fibers, carbon nanotubes, talc, mica, natural smectite clay, synthetic smectite clay, montmorillonite, saponite, hectorite, vermiculite, beidellite, or stevensite, and combinations thereof.

22. The system of claim 19, wherein said peroxide is selected from the group consisting of bis(t-butylperoxy) diisopropyl benzene; t-butyl peroxy-2-ethylhexanoate, dicumyl peroxide (DCP), acetyl cyclohexane sulphonyl peroxide, 2,5-dimethyl-2,5-di(t-butylperoxy) hexane, t-butyl peroxy-2-ethylhexanoate, di-t-butyl peroxide, 2,5-dimethyl-2,5-di(t-butylperoxy) hexyne-3, t-butyl peroxybenzoate, bis(t-butyl peroxyisopropyl) benzene, t-butyl hydroperoxide, dilauroyl peroxide, and combinations thereof.
